(19) United States
(12) Patent Application Publication
(10) Pub. No.: US 2024/0209828 A1
(43) Pub. Date: Jun. 27, 2024

(54) Tidal stream generation apparatus

(71) Applicants: Jia-Shing Lo, Taipei (TW); Wei-Lun Lo, Taipei (TW)

(72) Inventors: Jia-Shing Lo, Taipei (TW); Wei-Lun Lo, Taipei (TW)

(21) Appl. No.: 18/375,564

(22) Filed: Oct. 2, 2023

(30) Foreign Application Priority Data
Dec. 23, 2022 (TW) 111214310

(51) Int. Cl. F03B 13/26

(52) U.S. Cl. CPC F03B 13/26; F05B 2220/706; F05B 2260/502

(57) ABSTRACT

A generating apparatus for converting kinetic energy from a water flow to electrical energy includes a housing including an inlet, a passage, and an outlet; an actuation device including a cylindrical member secured to the housing; an actuation member pivotably secured to the cylindrical member and having a spring biased downward extension in the passage and a horizontal lever; and a striking member disposed on an end of the lever; a rotational device including a power wheel rotatably mounted on a column; and a generator operatively connected to the rotational device. The generator produces electrical power output in response to water currents flowing through the inlet and impinging the extension, both the extension and the lever pivoting counterclockwise, the striking member hitting the power wheel, and the power wheel rotating about to the column. There is a guide member at an end of the downward extension.

### BACKGROUND OF THE INVENTION

### 1. Field of the Invention

The invention relates to tidal stream generators and more particularly to a tidal stream generation apparatus adapted to extract energy from either tidal flow or river flow.

### 2. Description of Related Art

There is a conventional apparatus for generating electrical power from a horizontal water flow. The apparatus comprises a fixed hub on a support structure and a power wheel arranged for rotation about a vertical axis about the hub. The power wheel includes rotor vanes adapted to cause rotation of the power wheel when the power wheel is subject to a substantially horizontal water flow. At least one generator can be provided on the hub to produce electrical power output from rotation of the power wheel relative to the hub. A shroud is rotationally mounted on the hub and arranged to cover at least some of the rotor vanes, so that the water flow is concentrated on the rotor vanes on only one side of the power wheel. A directional controller holds the shroud in a predetermined rotational position relative to the hub dependent on the direction of the water flow.

While the apparatus enjoys its success in the market, a tidal stream generator adapted to extract energy from either tidal flow or river flow has not been disclosed as far as the present inventor is aware.

Thus, the need for improvement still exists.

### SUMMARY OF THE INVENTION

It is therefore one object of the invention to provide a generating apparatus for converting kinetic energy from a water flow to electrical energy, comprising a housing including an inlet, a passage rearward of the inlet, and an outlet rearward of the passage; an actuation device including a cylindrical member secured to the housing; an actuation member pivotably secured to the cylindrical member and having a spring biased downward extension disposed in the passage and a lever disposed perpendicularly to the downward extension, the lever having a length greater than that of the downward extension; and a striking member disposed on an end of the lever distal the cylindrical member; a rotational device including a column and a power wheel rotatably mounted on the column; and a generator operatively connected to the rotational device and configured to produce electrical power output in response to water currents flowing through the inlet and impinging the downward extension, both the downward extension and the lever pivoting counterclockwise, the striking member hitting the power wheel, and the power wheel rotating relative to the column.

The above and other objects, features and advantages of the invention will become apparent from the following detailed description taken with the accompanying drawings.

### BRIEF DESCRIPTION OF THE DRAWINGS

FIG. 1 is a longitudinal sectional view of a tidal stream generation apparatus according to the invention, the apparatus being ready to extract energy from a tidal or river flow;

FIG. 2 is a view similar to FIG. 1, the apparatus being hit by a tidal or river flow so as to extract energy therefrom; and

FIG. 3 is a block diagram of the tidal stream generation apparatus.

### DETAILED DESCRIPTION OF THE INVENTION

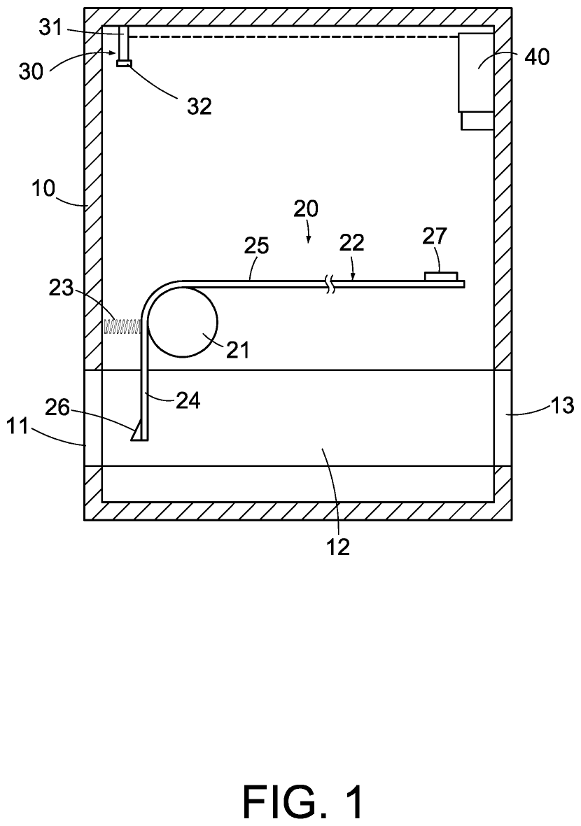

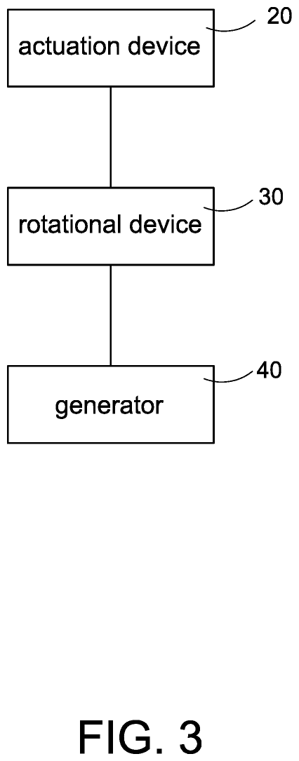

Referring to FIGS. 1 to 3, a tidal stream generation apparatus in accordance with the invention comprises a housing 10, an actuation device 20, a rotational device 30, and a generator 40 as detailed below.

The housing 10 is mounted on a sea bed or river bed and includes an inlet 11 for allowing a tidal flow or river flow to enter, a passage 12 rearward of the inlet 11, and an outlet 13 rearward of the passage 12.

The actuation device 20 includes a cylindrical member 21 secured to the housing 10; an actuation member 22 pivotably secured to the cylindrical member 21 and having a downward extension 24 disposed in the passage 12 (see FIG. 1) and a lever 25 disposed perpendicularly to the downward extension 24, the lever 25 having a length greater than that of the downward extension 24; a torsion spring 23 having a first end secured to the housing 10 and a second end secured to an upper portion of the downward extension 24; a guide member 26 disposed at an end of the downward extension 24 facing the inlet 11 for guiding water currents flowing through the passage 12; and a striking member 27 disposed on an end of the lever 25 distal the cylindrical member 21.

The rotational device 30 includes a column 31 secured to the housing 10 and a power wheel 32 rotatably mounted on the column 31.

The generator 40 is secured to the housing 10.

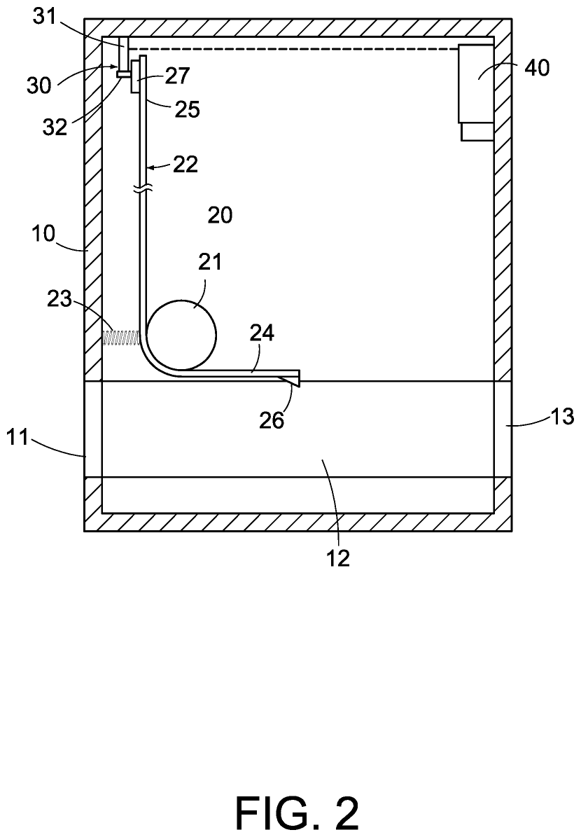

In response to water currents flowing through the inlet 11 and impinging the downward extension 24, both the downward extension 24 and the lever 25 (i.e., the actuation member 22) pivot counterclockwise with the torsion spring 23 being compressed. The striking member 25 may hit the power wheel 32 at the end of the counterclockwise rotation of the actuation member 22 (see FIG. 2). Thus, the power wheel 32 rotates relative to the column 31 and in turn, the generator 40 produces electrical power output from the rotation.

It is noted that the actuation member 22 may return to its inoperative position in FIG. 1 due to the expansion of the energized torsion spring 23 after the counterclockwise rotation of the actuation member 22.

While the invention has been described in terms of preferred embodiments, those skilled in the art will recognize that the invention can be practiced with modifications within the spirit and scope of the appended claims.

What is claimed is:

1. A generating apparatus for converting kinetic energy from a water flow to electrical energy, comprising:
a housing including an inlet, a passage disposed rearward of the inlet, and an outlet disposed rearward of the passage;
an actuation device including a cylindrical member secured to the housing; an actuation member pivotably secured to the cylindrical member and having a spring biased downward extension disposed in the passage and a lever disposed perpendicularly to the spring biased downward extension, the lever having a length greater than that of the spring biased downward extension; a guide member disposed at an end of the spring biased downward extension proximate the inlet; and a striking member disposed on an end of the lever distal the cylindrical member;
a rotational device including a column and a power wheel rotatably mounted on the column; and
a generator secured to the housing and operatively connected to the rotational device, the generator configured to produce electrical power output in response to water currents flowing through the inlet and impinging the downward extension, both the downward extension and the lever pivoting counterclockwise, the striking member hitting the power wheel, and the power wheel rotating relative to the column.
